(19) United States
(12) Patent Application Publication
(10) Pub. No.: US 2022/0170276 A1
(43) Pub. Date: Jun. 2, 2022

(54) DECORATIVE MATERIAL

(71) Applicant: Dai Nippon Printing Co., Ltd., Tokyo (JP)

(72) Inventors: Natsuo Sugita, Tokyo (JP); Kosuke Nakai, Tokyo (JP); Takaho Saito, Tokyo (JP); Koki Fujii, Tokyo (JP)

(73) Assignee: Dai Nippon Printing Co., Ltd., Tokyo (JP)

(21) Appl. No.: 17/442,222

(22) PCT Filed: Mar. 27, 2020
(86) PCT No.: PCT/JP2020/014174

§ 371 Date: Sep. 23, 2021

(30) Foreign Application Priority Data
Mar. 29, 2019 (JP) 2019-066971

(51) Int. Cl. E04F 13/08; B32B 3/30; B32B 27/08; B32B 27/30; B44F 9/04

(52) U.S. Cl. CPC E04F 13/0871; B32B 3/30; B32B 27/08; B32B 2307/732; B44F 9/04; B32B 2255/10; B32B 2255/26; B32B 27/304

(57) ABSTRACT

A decorative material including: a substrate; and a pattern formation layer provided on one surface of the substrate, the pattern formation layer having projections and recesses, wherein the pattern formation layer includes a plurality of areas that are arranged thereon and distinguished by difference in a surface profile, the surface profile of the first area is a rough surface, the surface profile of the second area includes a plurality of aligned projecting lines, the projecting lines each having a width of at least 10 μm and less than 250 μm, a height of more than 3 μm and less than 350 μm, and an interval to a projecting line adjacent thereto of more than 10 μm and less than 160 μm, and the surface profile of the third area is a smooth surface.

### TECHNICAL FIELD

The present invention relates to a decorative material.

### BACKGROUND ART

Decorative materials are widely used as materials to decorate surfaces of furniture, building materials, etc. For example, Patent Literature 1 discloses that a stone grain pattern layer, and further a transparent or semitransparent resin layer such as to cover the entire surface of the stone grain pattern layer are laminated in this order on a thermoplastic resin substrate, to provide a decorative sheet excellent in displaying designs of a three-dimensional effect such as a depth or a length of stone grain, and brightness of a crystal grain. The decorative sheet has a groove-shaped textured pattern formed of a pattern in the form of a track group which is partitioned into closed areas and has grooves aligning in different directions between each pair of the adjacent closed areas, on the interface between the stone grain pattern layer and the resin layer. The grooves each have a depth of 3 μm to 100 μm. The intervals between protruding parts of the pattern are each 1 μm to 1000 μm.

### CITATION LIST

### Patent Literature

Patent Literature 1: JP H8-52849 A

### SUMMARY OF INVENTION

### Technical Problem

An object of the present disclosure is to provide a decorative material capable of making an external appearance and a tactile sense different from conventional decorative materials to be felt when stone grain is displayed.

### Solution to Problem

One aspect of the present disclosure is a decorative material that includes a textured pattern formed thereon, the decorative material comprising: a substrate; and a pattern formation layer provided on one surface of the substrate, the pattern formation layer having projections and recesses, wherein the pattern formation layer includes a plurality of areas that are arranged thereon and distinguished by difference in a surface profile, a plurality of the areas include at least a first area, a second area and a third area, the surface profile of the first area is a rough surface having arithmetic mean roughness Ra (JIS B 0601-2001) of at least 5 μm and less than 60 μm, the surface profile of the second area includes a plurality of aligned projecting lines, the projecting lines each having a width of at least 10 μm and less than 250 μm, a height of more than 3 μm and less than 350 μm, and an interval to a projecting line adjacent thereto of more than 10 μm and less than 160 μm, and the surface profile of the third area is a smooth surface having arithmetic mean roughness Ra (JIS B 0601-2001) of less than 3 μm.

Further, in the decorative material, the pattern formation layer may include a difference in level. This difference in level may be made along at least a part of boundaries of the areas.

The substrate may be transparent, and a layer having a design may be laminated to the substrate on an opposite side of the one surface, where the pattern formation layer is provided.

### Advantageous Effects of Invention

The present disclosure can provide a decorative material that makes an external appearance and a tactile sense different from conventional decorative materials felt when stone grain is displayed.

### BRIEF DESCRIPTION OF DRAWINGS

FIG. 1 is a partially enlarged plan view showing a surface of a decorative material 10.

FIG. 2 is a partially enlarged schematic view of FIG. 1.

FIG. 3 is a schematic perspective view of the decorative material 10 to explain a form of a pattern formation layer 12.

FIG. 4 is an explanatory cross-sectional view of a second area 14.

FIG. 5 is a schematic perspective view of a decorative material 110 to explain a form of a pattern formation layer 112.

FIG. 6 is a plan view showing arrangement of differences in level in the form of the pattern formation layer 112.

FIG. 7 explanatorily shows a scene where recesses and projections are formed on a die with laser.

### DESCRIPTION OF EMBODIMENTS

Hereinafter the present disclosure will be described based on the embodiments shown in the drawings. The present invention is not limited to these embodiments. The following drawings may show changed or exaggerated sizes and proportions of the members for understandability. In addition, portions unnecessary for the description, and repeatedly appearing signs may be omitted for visibility.

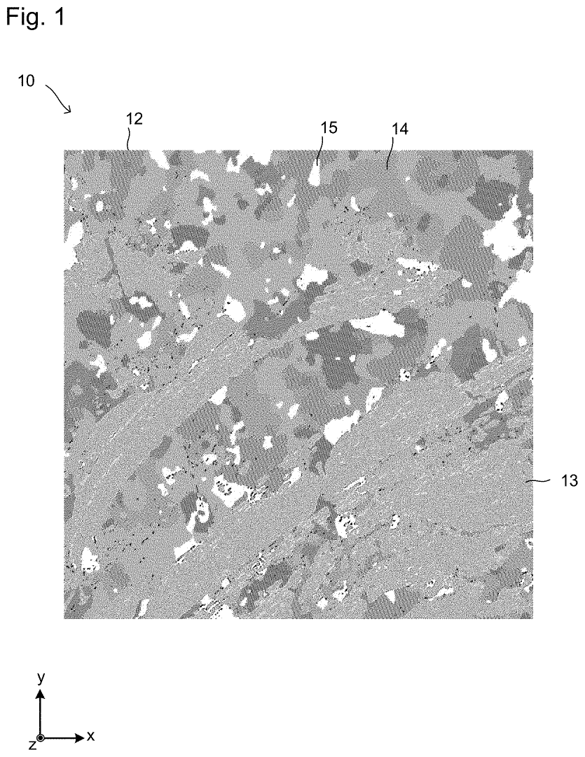

FIG. 1 is a partially enlarged plan view of a decorative material 10 according to the first embodiment on a pattern formation layer 12 side. In FIG. 1, the display of a design layer is excluded for clarity, and a pattern of recesses and projections which is formed on a pattern formation layer 12 is shown by lights and shades of black and white. Therefore, the pattern is not always formed of such lights and shades on the actual decorative material 10.

If necessary, for convenience, FIG. 1 and the following drawings also show the arrows (x, y and z) indicating directions, that is, a coordinate system. Here, directions x and y is any direction in the plane of the decorative material 10, and the direction z is a thickness direction thereof. Thus, FIG. 1 is a (plan) view of the decorative material 10 particularly in the direction z on the pattern formation layer 12 side.

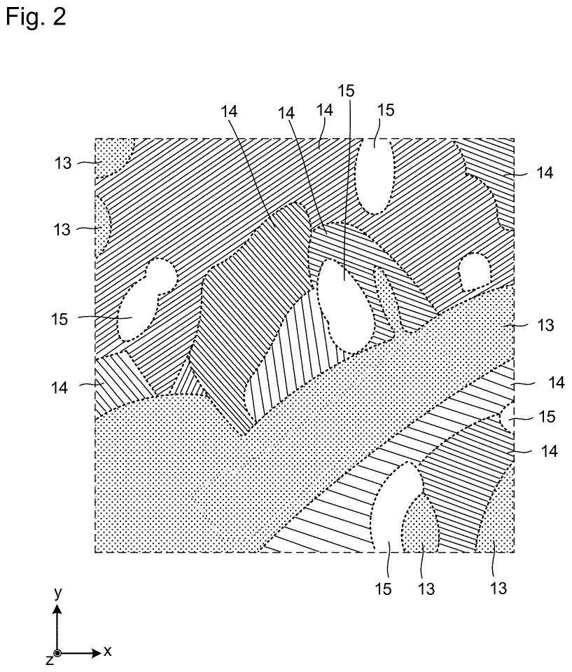

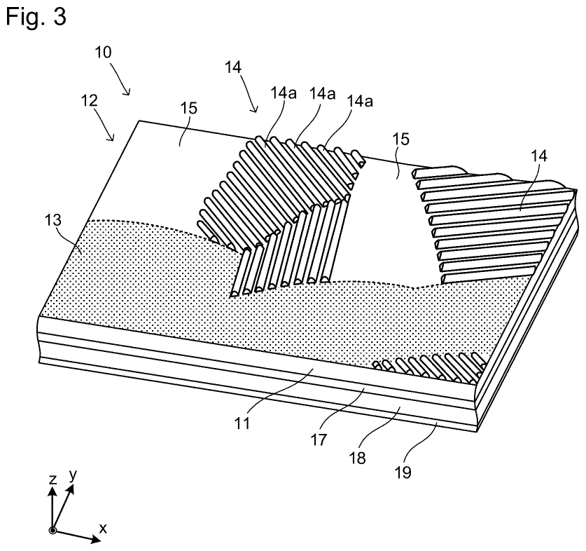

FIG. 2 is a partially enlarged schematic view of FIG. 1. FIG. 3 is a partially enlarged schematic perspective view of the decorative material 10 to more clearly explain the structure of the decorative material 10.

As can be seen from FIGS. 1 to 3, the decorative material 10 according to the present embodiment has a substrate 11, the pattern formation layer 12 provided on one surface of the substrate 11, and a design layer 17, a colored layer 18 and a back surface layer 19 which are laminated to the substrate 11 on the side opposite to the side where the pattern formation layer 12 is formed.

In the present invention, separate layers of the substrate 11 and the pattern formation layer 12 may form a laminated body, or a single layer may be used as both the substrate 11 and the pattern formation layer 12. In the embodiments according to the present disclosure, as shown in FIGS. 3, 4 and 5, a single layer is used as the substrate 11 and the pattern formation layer 12. The vicinity of one surface of the substrate 11 (surface on the positive side of the z-axis in, for example, FIG. 3) is formed into a textured pattern, to form the pattern formation layer 12.

Hereinafter the structure of each component will be described in more detail.

The substrate 11 is a sheet member having functions of holding the pattern formation layer 12, and giving the decorative material 10 strength. The substrate 11 may be in any form of a film, a sheet and a plate. Generally, a sheet member is referred to as a film, a sheet and a plate in the order of a relatively less thickness. In the present embodiment, this difference of the substrate in thickness is not an essential or important matter. Therefore, even if a film, a sheet or a plate is randomly read as any other term thereamong in the present description, the present invention never changes essentially, and claims never change interpretively.

The material of the substrate 11 is not particularly limited because having only to have the same functions as conventionally known decorative materials. As the material of the substrate, for example, any of the following is usually used: polyolefin resins such as polyethylene, polypropylene, olefinic thermoplastic elastomers, and ionomers; acrylic resins such as polymethyl methacrylate, and polybutyl methacrylate; thermoplastic polyester resins such as polyethylene terephthalate, and polybutylene terephthalate;

thermoplastic resins such as thermoplastic urethane resins, vinyl chloride resins, ABS resins (acrylonitrile-butadiene-styrene copolymers), and styrene resins; thermosetting resins such as melamine resins, unsaturated polyester resins, and two-liquid curable urethane resins; and ionizing radiation curable resins that are monomers or prepolymers of radical-polymerizable acrylates, cation-polymerizable epoxies, or the like and are cured by ionizing radiation (such as an ultraviolet ray and an electron beam). When made from a resin, the substrate may be colored by any known colorant. Other than the above resin materials, paper, a nonwoven fabric, metal, wood, or the like may be also used in the form of a sheet, a plate, a 3D object, or the like by suitably laminating them onto any of the above resin materials.

When the design layer 17 laminated to the substrate 11 on the side opposite to the pattern formation layer 12 is included as the present embodiment, the substrate 11 is transparent so that the design of the design layer 17 appears.

The thickness of the substrate is not particularly limited. A sheet or film substrate having a thickness of, for example, approximately 20 μm to 1000 μm is used. A plate substrate having a thickness of, for example, approximately 1 mm to 20 mm is used.

The pattern formation layer 12 is provided on one surface of the substrate 11, and provides the decorative material with a textured pattern. In the present embodiment, the pattern formation layer 12 is formed to be particularly suitable for displaying a textured pattern of stone grain on the decorative material 10. As can be seen from FIGS. 1 to 3, the pattern formation layer 12 has the following form in the present embodiment. Here, a textured pattern is a patterned textured shape including each peculiar textured surface profile of first areas 13, second areas 14 and third areas 15 as described below or as shown in each drawing.

In this embodiment, the pattern formation layer 12 is provided with the first areas 13, the second areas 14 and the third areas 15. Each of the plural areas is arranged in the plane xy, to form the pattern formation layer 12.

The profile of each area viewed in the direction z is not particular limited, and may be in a definite or indefinite form. In view of display of natural stone grain, the profile may be formed so as to be in an indefinite form, and so that there are flows in a predetermined direction when the decorative material 10 as a whole is seen.

Any portion with which the outlines of the areas and the boundaries between the adjacent areas are edged is not necessary. The outlines and boundaries may naturally appear from difference between the patterns provided on the areas as described later. In such a view, in FIGS. 2 and 3, the outlines of the areas and the boundaries between the adjacent areas are represented by dotted lines, so as to be distinguished from the real lines.

The first areas 13 have a surface having a textured surface profile formed of micro-roughness, that is what is called a rough surface, sand grain, or a matte surface. Therefore, in the first areas 13, the surface has micro-roughness having no large difference in surface roughness between directions x and y.

Specifically, among the surface roughness, the arithmetic mean roughness Ra (JIS B 0601-2001) of this surface can be at least 5 gm and less than 60 μm, and may be 5 μm to 20 μm. Furthermore, this surface may be formed so that this surface roughness is within the above range at the same measurement position irrespective of the measurement direction.

The decorative material 10 may have a portion where adjacent areas are the first areas 13. In this case, the adjacent first areas 13 may be formed so as to have different surface textures such as surface roughness, so as to be visually distinguishable from each other.

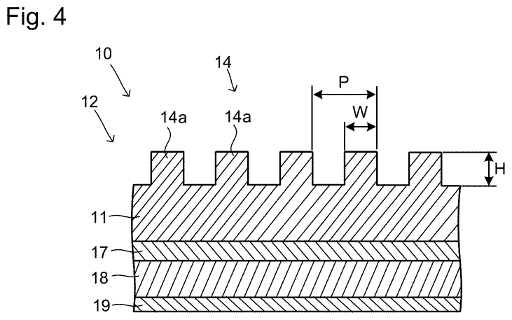

The second areas 14 are areas each including a projecting line group formed by a plurality of aligning projecting lines 14a as a textured surface profile therewithin. FIG. 4 shows a partial cross section of the second area 14 in the decorative material 10 in the thickness direction (direction z). FIG. 4 shows a cross section in a direction orthogonal to the extending direction of the projecting lines 14a. As shown in FIGS. 3 and 4, in the present embodiment, a plurality of the projecting lines 14a linearly extending in the same direction are aligned within any of the second areas 14.

Specific sizes of the height, width and length of each of the projecting lines 14a are not particularly limited. The sizes are preferably minute in view of formation of the textured pattern of stone grain on the decorative material. In such a view, the projecting lines are preferably in the following form.

The width W of each of the projecting lines (size in a direction orthogonal to the extending direction of the projecting lines in a plan view) at the widest portion is preferably at least 10 μm and less than 250 μm, and more preferably 15 μm to 30 μm.

The height H of each of the projecting lines (size in the direction z) at the highest portion is preferably more than 3 μm and less than 350 μm, and more preferably 100 μm to 200 μm.

The lengths of the projecting lines (the lengths in the extending direction of the projecting line) are fixed by the size of the area.

In this embodiment, a plurality of the projecting lines in each area all extend in the same direction in the area, but are not necessary to be strictly parallel. The projecting lines in each area are not necessary to be all in the same direction either. A plurality of projecting lines in each area preferably all extend in approximately the same direction in the area.

The interval P between adjacent projecting lines in the area is not particularly limited, but is preferably minute. Specifically, the interval P may be more than 10 μm and less than 160 μm, and more preferably 25 μm to 70 μm.

The shape of a cross section orthogonal to the extending direction of the projecting lines 14a is not particularly limited, but may be suitably set. Other than a quadrangle like in the present embodiment, this shape may be, for example, a semicircle, a semiellipse, a triangle, any other polygon, an indeterminate form, or a shape in combination thereof.

The decorative material 10 may have a portion where adjacent areas are the second areas 14. In this case, the adjacent second areas 14 may be formed so that the projecting lines in one of the adjacent second areas 14 may be different from those in the other in at least one of the extending direction, the width, the height, the cross-sectional shape, and the interval. This results in alignment of various kinds of the projecting lines, which leads to change of a gleaming portion according to a direction where the decorative material is seen so that an appearance closer to real stone grain can be obtained.

The third areas 15 are areas each formed of a smoothed textured surface profile. Specifically, among the surface roughness, the arithmetic mean roughness Ra (JIS B 0601-2001) of this surface may be less than 3 μm, and is more preferably at most 1.5 μm. Furthermore, this surface may be formed so that this surface roughness is within the above range at the same measurement position irrespective of the measurement direction.

Designs are drawn on the design layer 17. In the present embodiment, the design layer 17 is laminated to a face of the substrate 11 which is on the opposite side of the face thereof provided with the pattern forming layer 12.

Any specific design as the following may be arranged on the design layer 17: a pattern of stone grain of a cleavage plane of slate of granite (which is formed by aggregation of a lot of single crystal particles); various patterns of, for example, marbled or onyx-designed surfaces of stone which are typically surfaces and fracture faces of slate of granite, marble, sandstone, etc. for accenting the impression of the surface of stone; a color pattern; a photograph; a painting; a drawing; a geometrical pattern; or the like.

“Marbled (design)” is a pattern imitating marble, and is a design looking as if multicolored flowing shapes were superposed or kneaded. Example of such a pattern include a pattern using a drawing technique of: floating paint or black ink on a liquid having a high specific gravity; and dyeing the layer a floated pattern, like so-called “ink floating” or “marbling”.

“Onyx-designed” is a pattern imitating semitransparent limestone showing a parallel banded structure due to precipitation.

The design layer 17 may have a design according to the textured pattern of the pattern formation layer 12. At this time, the design may have a shape according to, or different from the recesses and projections on the pattern formation layer 12.

For example, such a design on the design layer 17 may be formed by an ink layer that is formed by printing such as gravure printing, silk screening, and ink jet printing.

An ink included in the design layer 17 has only to be suitably selected among known ones according to color tones of the design, and required physical properties. For example, as a binder resin for the ink, one of an acrylic resin, a vinyl chloride—vinyl acetate copolymer, a cellulose resin, a urethane resin, a polyester resin, a styrene resin, a chlorinated polyolefin resin, a polyvinyl butyral resin, an alkyd resin, a ketone resin, an epoxy resin, a melamine resin, a fluorine-based resin, a silicone-based resin, a cellulose derivative, and the like may be used alone, or two or more of them may be used in combination.

For example, as a colorant (such as a pigment and a die), any of the following may be used: a white colorant such as titanium white and flowers of zinc; a black colorant such as carbon black (black ink), iron black, and azomethine azo pigments; a yellow colorant such as chrome yellow, titanium yellow, polyazo yellow, isoindolinone yellow, and nickel azo complexes, a red colorant such as red iron oxide, cadmium red, polyazo red, and quinacridone red; a blue colorant such as ultramarine blue, cobalt blue, and phthalocyanine blue; a metallic pigment made from flakelike foil of aluminum, brass, etc.; and a pearl pigment made from flakelike foil of titanium dioxide coated mica, basic lead carbonate, etc.

In this embodiment, the pattern formation layer 12 is formed on one surface of the substrate 11, and the design layer 17 is laminated to the other surface of the substrate 11, which is on the opposite side of the one surface. The present invention is not limited to this. The design layer 17 may be formed and the pattern formation layer 12 may be provided on one side of the substrate 11.

The colored layer 18 may be provided if necessary, when the design layer 17 is laminated to the substrate 11 on the opposite side of the pattern formation layer 12 as in this embodiment. The material of the colored layer 18 is not particularly limited. For example, any of the following is colored with a known colorant to be used: polyolefin resins such as polyethylene, polypropylene, olefinic thermoplastic elastomers, and ionomers; acrylic resins such as polymethyl methacrylate, and polybutyl methacrylate; thermoplastic polyester resins such as polyethylene terephthalate, and polybutylene terephthalate; thermoplastic resins such as thermoplastic urethane resins, vinyl chloride resins, ABS resins (acrylonitrile-butadiene-styrene copolymers), and styrene resins; thermosetting resins such as melamine resins, unsaturated polyester resins, and two-liquid curable urethane resins; and ionizing radiation curable resins that are monomers or prepolymers of radical-polymerizable acrylates, cation-polymerizable epoxies, or the like and are cured by ionizing radiation (such as an ultraviolet ray and an electron beam). Paper, metal, wood, or the like may be also used in the form of a sheet, a plate, a 3D object, or the like by suitably laminating them to the substrate 11.

The back surface layer 19 may be provided if necessary for improving adhesion. The major constituent of the back surface layer 19 is preferably a resin. The following are given as the resin of a primer layer: an ester resin, an urethane resin, an acrylic resin, a polycarbonate resin, a vinyl chloride—vinyl acetate copolymer, and the like. The resin of the primer layer may be a two-liquid curable resin. Among these resins, a two-liquid curable resin is preferable in view of adhesion.

The two-liquid curable resin is not particularly limited as long as being a resin cured when a curing agent is added to a basis. A two-liquid curable urethane resin for which the basis is a polyol (polyhydric alcohol) and the curing agent is an isocyanate curing agent is preferable.

The thickness of the primer layer is usually approximately 0.5 μm to 20 μm, and may be in the range of 1 μm to 10 μm.

At least all of the first area 13, the second area 14 and the third area 15 are included in the decorative material 10 according to the present embodiment. However, it is not necessary that any area of the decorative material be one of the first area, the second area and the third area. The decorative material may include an area of another shape that does not satisfy any shape of the first area, the second area and the third area.

The decorative material of the above described structure can make an external appearance and a tactile sense different from conventional decorative materials felt when stone grain is displayed.

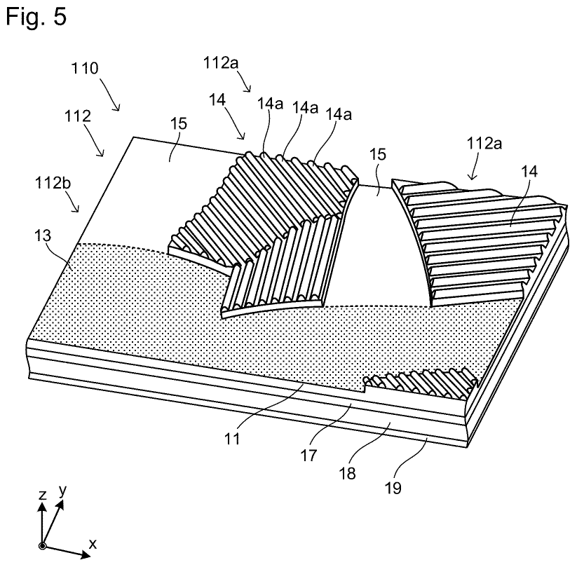

FIG. 5 explanatorily shows a decorative material 110 according to the second embodiment, and is a perspective view in the same view as FIG. 3.

As can be seen from this drawing, in the decorative material 110 according to the present embodiment, a pattern formation layer 112 is provided with the first area 13, the second areas 14 and the third areas 15, and a difference in level is made at boundaries of a part of the areas so that projecting areas 112a and a recessed area 112b are provided.

This leads to a decorative material that can further make an external appearance and a tactile sense different from conventional decorative materials felt when stone grain is displayed.

The difference between the projecting areas 112a and the recessed area 112b in height (direction z) is not particularly limited, but may be approximately 10 μm to 100 μm, and can be approximately 20 μm to 60 μm.

In the present embodiment, there is one difference in level. There may be at least two differences in level however. That is, at least three areas having different heights, such as a first recessed area lower than the projecting areas as the standard, a second recessed area lower than the first recessed area, . . . , may be provided.

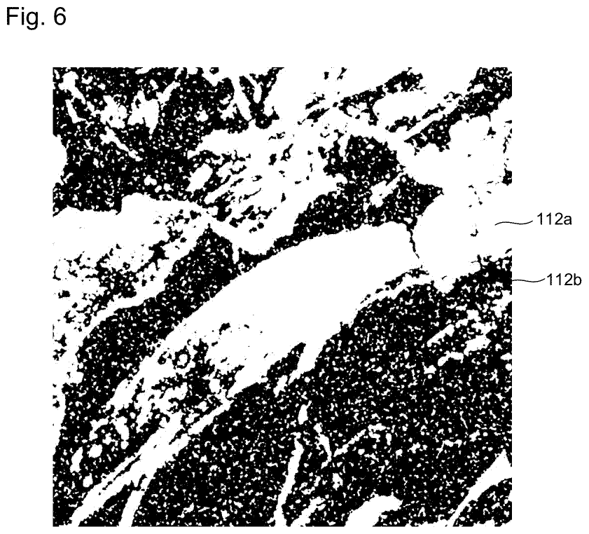

FIG. 6 shows the differences in level in black and white as one example. Black portions show the projecting areas 112a and white portions show the recessed area 112b. This is in the same view as FIG. 1. That is, the decorative material 110 according to the present embodiment is formed of the differences in level made by the projecting areas 112a and the recessed area 112b shown in FIG. 6 in further combination with the first areas 13, the second areas 14 and the third areas 15 shown in FIG. 1.

Next, an example of a method for manufacturing a decorative material will be described using the decorative material 10 as an example. The method for manufacturing a decorative material is not limited to this example.

The manufacturing method described as follows includes the step of creating an original image, the step of creating a block copy image, the step of making a plate, and the step of forming a pattern formation layer.

In the step of creating an original image, a pattern (stone grain pattern) in a plan view which is to be displayed in the pattern formation layer 12 is obtained and used as an original image.

In the step of creating a block copy image, a pattern in a plan view which is to be displayed on the surface of the substrate 11 on the pattern formation layer 12 side is obtained as density (lights and shades) of the image, and used as a block copy image. The block copy image is preferably in the form of digital data. Thus, when the original image is not in the form of digital data, digital data that is formed by aligning pixels in a two-dimensional coordinate plane (x, y), and allocating a density value unique to each pixel to each pixel is obtained by using a means of reading the original image with a scanner, and subjecting the read image to AD conversion. When the original image is designed in the form of digital data first of all using CAD or the like, this digital data may be used.

Then, the first area, the second area and the third area are allocated in the digital data. Further, with a conversion program from the density to the projections and recesses for each area, a pattern of each area as a binary image is created on a two-dimensional assumed plane correspondingly to a gradation image of the pattern and is arranged, so that the block copy image as digital data is obtained.

In the step of making a plate, an embossed plate (molding die for decorative materials) having a pattern of a shape in a plan view like FIG. 1 on a surface thereof is made based on the block copy image. Specifically, the step of producing a textured pattern includes the following procedures (1) to (5).

### (1) Step of Creating Density Image Data

Using graphic design drawing software “Photoshop” created by Adobe Systems Incorporated, 8-bit TIFF lights and shades image data (having 256 gradations in the grey scale of the image) with a resolution of 2540 dpi is created. This lights and shades image data is also referred to as textured pattern image data.

### (2) Step of Preparing Metal Roll

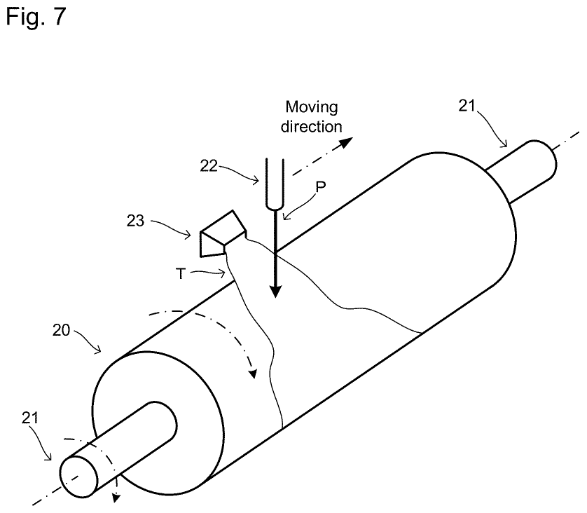

A metal roll 20 for chasing embossed plates as shown in FIG. 7 is prepared. The metal roll 20 is obtained by plating a copper layer on a surface of a hollow iron cylinder that has a rotation driving axis (shaft) 21 at both end portions in the axis direction. The surface of the metal roll 20 is polished by a whetstone to be a rough surface, to be treated so that specular reflection of laser light for chasing is prevented from deteriorating chasing efficiency.

### (3) Step of Chasing with Laser Light

The surface of the metal roll 20, which is prepared in the step (2), is chased using a laser light direct chaser based on the pattern formation layer image data, which is created in the step (1), as schematically shown in FIG. 7. This leads to, on the surface of the metal roll 20, formation of a textured shape that has inverse recesses and projections to, and the same shape in a plan view as the textured pattern on the surface of the decorative material as shown in FIG. 1 (having the relationship such that portions corresponding to projecting lines on the decorative material are recessed lines on the surface of the embossed plate).

Therefore, a shape that the textured pattern on the embossed plate is to have is a form such that the relationship of recesses and projections on the textured pattern by the projecting lines of the decorative material is reversed, and may be considered the same as the decorative material.

The metal roll 20 is driven by an electric motor via the rotation driving axis 21, to be rotated as using the rotation driving axis 21 as the central axis. The surface of the metal roll 20 is scanned with laser light P that is emitted from a laser head 22. The irradiation with the laser light is carried out in a state where liquid for chasing T is sprayed from an exhaust port for liquid for chasing 23 onto an area irradiated with the laser light which is on the surface of the metal roll 20, in order to prevent powder converted from the vaporized metal from remaining or adhering to the surface of the metal roll 20.

### (4) Electropolishing Step

After the liquid for chasing is washed away, electropolishing is carried out to remove the residue of the metal adhered to the surface of the metal roll 20.

### (5) Step of Chrome Plating

After the step (4), a chromium layer having a thickness of 10 μm is formed on the surface of the metal roll by plating.

The foregoing makes it possible to obtain a plate (die for molding decorative materials, the embossed plate in the present embodiment) including a textured surface profile that is formed of inverse recesses and projections to the textured pattern on the pattern formation layer 12.

Next, in the step of forming a pattern formation layer, the decorative material 10 is obtained by embossing the substrate 11 using the made plate (embossed plate). The embossing may be carried out by any suitable known method without any particular limitations. Examples of typical embossing methods include the following.

A resin sheet made from a thermoplastic resin such as polyolefin resins is used as the substrate. This substrate is heated and softened. The embossed plate is pressed onto a surface of the substrate to form the textured pattern on the surface of the embossed plate, on the surface of the resin sheet. Then, the resin sheet is cooled and cured, and then the textured pattern thereon is fixed. Thereafter the resin sheet, on which the textured pattern is formed, is removed from the embossed plate.

Here, a variety of embossing methods such as the following (A) to (E) will be further described.

(A) A resin sheet that is to be the substrate is heated and softened. The embossed plate is pressed onto, and embosses the resin sheet.

(B) A resin sheet (substrate) that is to be a surface sheet by heat and pressure when the embossed plate is pressed, and a resin sheet (second substrate) that is to be a base sheet are thermal-bonded, to be embossed by the doubling embossing method of carrying out embossing and laminating at the same time.

(C) A resin sheet (substrate) that is to be a surface sheet is subjected to melt extrusion via a T-die, and made to be in contact with the top of a cylindrical embossed plate that also functions as a cooling roller, to be embossed at the same time when the surface sheet is formed. At this time, a resin sheet (second substrate) that is to be a base sheet and is inserted on the back side of the surface sheet is further thermal-bonded, to be subjected to doubling embossing at the same time as the sheet formation.

(D) As disclosed in, for example, JP S57-87318 A and JP H7-32476 A, a surface of a cylindrical embossed plate is coated with an uncured liquid of an ionizing radiation curable resin. Further, the top of the surface is irradiated with ionizing radiation as a base sheet formed of a resin sheet or the like is laminated thereto, and the uncured liquid is cured to be a cured material. At this time, this cured material is adhered to the base sheet, and thereafter removed from the embossed plate, to constitute a substrate that is formed of the base sheet and the cured material on the base sheet, which results in the embossed substrate.

(E) Impregnated paper that is obtained by impregnating an uncured material of a thermosetting resin such as melamine resins with paper such as titanium paper is placed on a backing material such as core paper and plywood. A plurality of these placed layers are subjected to heat press molding to be unitedly laminated, so that a thermosetting resin decorative material is made. At this time, the embossed plate is inserted on the surface side of the impregnated paper, which results in a surface of the paper embossed at the same time as heat pressing when the thermosetting resin is impregnated and cured to constitute the decorative material.

A thermoplastic resin is typically used as the material of the substrates used in the embossing methods (A) to (C). An ionizing radiation curable resin is typically used as the material of the substrate used in the embossing method (D). A thermosetting resin is typically used as the material of the substrate used in the embossing method (E).

Then, the design layer 17 is printed on the substrate 11, and the colored layer 18 is laminated to the back surface layer 19, so that the decorative material 10 can be obtained.

Use of the foregoing decorative material is not particularly limited, but examples thereof include interior materials for buildings such as walls, floors, and ceilings; exterior materials for buildings such as exterior walls, roofs, gates, walls, and fences; fittings such as doors, window frames, and door frames; facing materials for millwork such as crown moldings, skirting boards, and handrails; facing materials for housings of home appliances such as TV sets and refrigerators, and of office equipment such as copying machines; facing materials for furniture such as chests of drawers; facing materials for containers such as boxes and resin bottles; interior and exterior materials for vehicles etc.; and interior and exterior materials for vessels.

### EXAMPLES

In Examples, the first area, the second area and the third area were evaluated as presence or absence thereof and the forms thereof were changed.

Concerning a decorative material, first, a design printed sheet was prepared by coating a colored polyvinyl chloride (PVC) film having a thickness of 150 μm with a design printed layer using a blended resin-based ink of vinyl chloride and acrylic by gravure printing.

Next, a transparent PVC film having a thickness of 300 μm was laminated to the prepared design printed sheet on the design printed layer side with an embosser. At the same time, an embossed plate was pressed to give a textured pattern of a pattern formation layer (conditions: 8 m/min in speed; 80° C. in temperature of the embossed plate; and 4.5 kgf in pressure for embossing). A desired decorative material was prepared by the above steps.

Specific forms and evaluations are shown in Table 1. Here, it was visually evaluated by randomly selected 20 adults whether the decorative material of each example had natural texture of a depth of stone grain, and brightness of a crystal grain under the illumination of a fluorescent lamp. The results of this were evaluated with good and bad. good: at least 18 persons answered that the decorative material had natural texture no: at most 17 persons answered that the decorative material had natural texture

TABLE 1

| | First area | | | | Third area | |
|---|---|---|---|---|---|---|
| | (rough surface) | Second area (projecting lines aligned) | | | (smooth surface) | |
| | Surface roughness | Width of projecting line | Height of projecting line | Interval | Surface roughness | |
| | Ra (μm) | W (μm) | H (μm) | P (μm) | Ra (μm) | Evaluation |
| Example 1 | 5 | 30 | 200 | 70 | 1.5 | good |
| Example 2 | 5 | 15 | 100 | 25 | 1.5 | good |
| Example 3 | 20 | 30 | 200 | 70 | 1 | good |
| Comparative Example 1 | First area | 30 | 200 | 70 | 1.5 | bad |
| | not provided | | | | | |
| Comparative Example 2 | 5 | Second area not provided | | | 1.5 | bad |
| Comparative Example 3 | 5 | 30 | 200 | 70 | Third area | bad |
| | | | | | not provided | |
| Comparative Example 4 | 2 | 30 | 200 | 70 | 1.5 | bad |
| Comparative Example 5 | 60 | 30 | 200 | 70 | 1.5 | bad |
| Comparative Example 6 | 5 | 8 | 3 | 10 | 1.5 | bad |
| Comparative Example 7 | 5 | 250 | 350 | 160 | 1.5 | bad |
| Comparative Example 8 | 5 | 30 | 200 | 70 | 3 | bad |

As can be seen from Comparative Examples 1 to 3 of Table 1, the result was bad in the case where any of the first area to the third area was not provided.

As can be seen from Comparative Examples 4 and 5, the result was bad in the case where the surface roughness Ra was at most 2 μm or at least 60 μm in the first area.

As can be seen from Comparative Examples 6 and 7, the result was bad in the case where a projecting line portion had a width of at most 8 μm or at least 250 μm, a height of at most 3 μm or at least 350 μm, and an interval between adjacent projecting lines of at most 10 μm or at least 160 μm in the second area.

As can be seen from Comparative Example 8, the result was bad in the case where the surface roughness Ra was at least 3 μm in the third area.

### REFERENCE SIGNS LIST

10, 110 decorative material

11 substrate

12, 112 pattern formation layer

13 first area

14 second area

14a projecting line

15 third area

1. A decorative material that includes a textured pattern formed thereon, the decorative material comprising:
a substrate; and
a pattern formation layer provided on one surface of the substrate, the pattern formation layer having projections and recesses, wherein
the pattern formation layer includes a plurality of areas that are arranged thereon and distinguished by difference in a surface profile,
a plurality of the areas include at least a first area, a second area and a third area,
the surface profile of the first area is a rough surface having arithmetic mean roughness Ra (JIS B 0601-2001) of at least 5 μm and less than 60 μm,
the surface profile of the second area includes a plurality of aligned projecting lines, the projecting lines each having a width of at least 10 μm and less than 250 μm, a height of more than 3 μm and less than 350 μm, and an interval to a projecting line adjacent thereto of more than 10 μm and less than 160 μm, and
the surface profile of the third area is a smooth surface having arithmetic mean roughness Ra (JIS B 0601-2001) of less than 3 μm.

2. The decorative material according to claim 1, wherein the pattern formation layer further includes a difference in level.

3. The decorative material according to claim 2, wherein the difference in level is made along at least a part of boundaries of the areas.

4. The decorative material according to claim 1, wherein
the substrate is transparent, and a layer having a design is laminated to the substrate on an opposite side of the one surface, where the pattern formation layer is provided.
